(19) United States
(12) Patent Application Publication
(10) Pub. No.: US 2013/0133423 A1
(43) Pub. Date: May 30, 2013

(54) DEVICE FOR DETECTING MOTIONS AND METHOD FOR DETECTING MOTIONS

(71) Applicants: Kyung Rin Kim, Gyeonggi-do (KR); Byoung Won Hwang, Gyeonggi-do (KR); Chang Hyun Kim, Gyeonggi-do (KR)

(72) Inventors: Kyung Rin Kim, Gyeonggi-do (KR); Byoung Won Hwang, Gyeonggi-do (KR); Chang Hyun Kim, Gyeonggi-do (KR)

(21) Appl. No.: 13/415,752

(22) Filed: Mar. 8, 2012

(30) Foreign Application Priority Data
Nov. 30, 2011 (KR) 10-2011-0126985

(51) Int. Cl. G01P 3/04

(52) U.S. Cl. 73/510

(57) ABSTRACT

Disclosed herein are a device for detecting motions and a method for detecting motions. The device for detecting motions includes a sensor detecting motions to output detection result signals; an accumulation operation unit accumulatively summing absolute values of the detection result signals in a preset accumulation period to derive signal accumulation values; a motion determination unit comparing the signal accumulation values with a preset first reference value to determine whether the motions are present; and an output unit outputting motion detection signals according to determination results of the motion determination unit. By this configuration, the exemplary embodiments of the present invention can reflect a size of the detection result signals to motion detection while improving inaccuracy of the motion detection according to a fixing of a threshold value.

### CROSS REFERENCE(S) TO RELATED APPLICATIONS

This application claims the benefit under 35 U.S.C. Section 119 of Korean Patent Application Serial No. 10-2011-0126985, entitled “Device for Detecting Motions and Method for Detecting Motions” filed on Nov. 30, 2011, which is hereby incorporated by reference in its entirety into this application.

### BACKGROUND OF THE INVENTION

1. Technical Field

The present invention relates to a device for detecting motions and a method for detecting motions, and more particularly, to a device for detecting motions and a method for detecting motions detecting whether motions are present by using an accumulated value of signals output from a sensor.

2. Description of the Related Art

Various sensors that electrically or magnetically detect motions of persons or objects and output the detected motions as analog signals and/or digital signals have been developed.

The sensors are various depending on the principles, such as an acceleration sensor, an angular velocity sensor, a gyro sensor, a geomagnetic sensor, an optical sensor, or the like.

In this case, the acceleration sensor, the angular velocity sensor, the gyro sensor, or the like, are a sensor measuring an inertial force and therefore, is generally referred to as an inertial sensor. Recently, a technology of using various applications has been continuously developed by simultaneously measuring an acceleration sensor and an angular velocity sensor.

Output values obtained from these sensors are converted and output into analog or digital values. These output values may be reflected and used for various applications.

Meanwhile, a function of detecting motions of the inertial sensor determines that motions are present in an object or a region to be detected by a sensor by using signals applied from the outside of the inertial sensor, which is a function of providing information on the motions to a host device or other control devices.

As a representative method for detecting motions, a method for determining whether the motions are present by setting a fixed threshold value and comparing the threshold value with the signals output from the sensor.

FIG. 1 is a diagram for explaining a motion detecting principle according to the related art.

Referring to FIG. 1, when detection result signals output from the sensor have waveforms as shown in a top of FIG. 1, a general motion detecting process according to the related art is performed in a manner of outputting the motion detection signals as shown at a bottom of FIG. 1 by simply comparing the detection result signal with the threshold value. That is, it is determined that the motions are absent in a period in which the detection result signal is smaller than the threshold value and it is determined that the motions are present in a period in which the detection result signal is larger than the threshold value.

However, the related art cannot determine the motion in connection with the detection result signals smaller than the threshold value and therefore, cannot detect the motions and frequently detect and output the motions when the threshold value is set to be too small.

In addition, when the detection result signals are frequent in a range approaching the set threshold value, excessive motion detection results are output and therefore, unnecessary overload may be applied to the host device, the control unit, or the like.

In addition, the related art may determine that the motions are present without considering the size of the detection result signal when the detection result signal is larger than the threshold value and cannot therefore reflect the size of the detection result signal.

### SUMMARY OF THE INVENTION

An object of the present invention is to provide a device for detecting motions and a method for detecting motions capable of determining whether motions are present by performing an accumulation operation on the detection result signals in a predetermined period so as to reflect a size of the detection result signals to motion detection while improving inaccuracy of motion detection according to a fixed threshold value

According to an exemplary embodiment of the present invention, there is provided a device for detecting motions, including: a sensor detecting motions to output detection result signals; an accumulation operation unit accumulatively summing absolute values of the detection result signals in a preset accumulation period to derive signal accumulation values; a motion determination unit comparing the signal accumulation values with a preset first reference value to determine whether the motions are present; and an output unit outputting motion detection signals according to determination results of the motion determination unit.

The accumulation operation unit may further include a sampling unit sampling the detection result signals or the absolute values of the detection result signals at a predetermined time interval.

The sampling unit may further include a sampling interval determination unit determining a time interval at which the sampling is performed.

The accumulation operation unit may further include an accumulation period determination unit determining a size of the accumulation period.

The device for detecting motions may further include an accumulation period determination unit determining a size of the accumulation period.

According to another exemplary embodiment of the present invention, there is provided a device for detecting motions, including: a sensor detecting motions to output detection result signals; a sampling unit sampling absolute values of the detection result signals at a predetermined time interval; a fine tremor removing unit comparing values sampled by the sampling unit with a preset second reference value to pass through only a value larger than the second reference value; an accumulation operation unit accumulatively summing values passing through the fine tremor removing unit in a preset accumulation period to derive signal accumulation values; a motion determination unit comparing the signal accumulation values with a preset first reference value to determine whether the motions are present; and an output unit outputting motion detection signals according to determination results of the motion determination unit.

The sampling unit may further include a sampling interval determination unit determining a time interval at which the sampling is performed.

The device for detecting motions may further include an accumulation period determination unit determining a size of the accumulation period.

According to another exemplary embodiment of the present invention, there is provided a method for detecting motions, including: (a) detecting motions in a sensor to output detection result signals; (b) accumulatively summing absolute values of the detection result signals in a preset accumulation period to derive signal accumulation values; (c) comparing the signal accumulation values with a preset first reference value to determine whether the motions are present; and (d) outputting motion detection signals according to results determining whether the motions are present.

Step (c) may determine that the motions are present when the signal accumulation values are the first reference value or more, and determine that the motions end when the signal accumulation values are smaller than the first reference value.

According to another exemplary embodiment of the present invention, there is provided a method for detecting motions, including: (A) detecting motions in a sensor to output detection result signals; (B) sampling absolute values of the detection result signals at a predetermined time interval; (C) comparing sampled values with a preset second reference value to pass through only a value larger than the second reference value; (D) accumulatively summing the passing values at step (C) in a preset accumulation period to derive signal accumulation values; (E) comparing the signal accumulation values with a preset first reference value to determine whether the motions are present; and (F) outputting motion detection signals according to result determining whether the motions are present.

Step (E) may determine that the motions are present when the signal accumulation values are the first reference value or more, and determine that the motions end when the signal accumulation values are smaller than the first reference value.

### BRIEF DESCRIPTION OF THE DRAWINGS

FIG. 1 is a diagram for explaining a motion detection principle according to the related art.

FIG. 2 is a diagram schematically showing a device for detecting motions according to an exemplary embodiment of the present invention.

FIG. 3 is a diagram schematically showing a device for detecting motions according to another exemplary embodiment of the present invention.

FIG. 4 is a diagram schematically showing motion result signals according to an exemplary embodiment of the present invention.

FIG. 5 is a diagram schematically showing motion detection signals and a deriving principle thereof according to an exemplary embodiment of the present invention.

FIG. 6 is a diagram schematically showing motion detection signals and a deriving principle thereof according to another exemplary embodiment of the present invention.

FIG. 7 is a diagram schematically showing a device for detecting motions according to another exemplary embodiment of the present invention.

FIG. 8 is a diagram schematically showing the sensing result signals according to another exemplary embodiment of the present invention.

FIG. 9 is a diagram schematically showing motion detection signals and a deriving principle thereof according to another exemplary embodiment of the present invention.

FIG. 10 is a diagram schematically showing a comparative example of FIG. 9.

FIG. 11 is a flow chart schematically showing a method for detecting motions according to an exemplary embodiment of the present invention.

FIG. 12 is a flow chart schematically showing a method for detecting motions according to another exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. Rather, these embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an acting effect of exemplary embodiments of the present invention will be described in more detail with reference to the accompanying drawings.

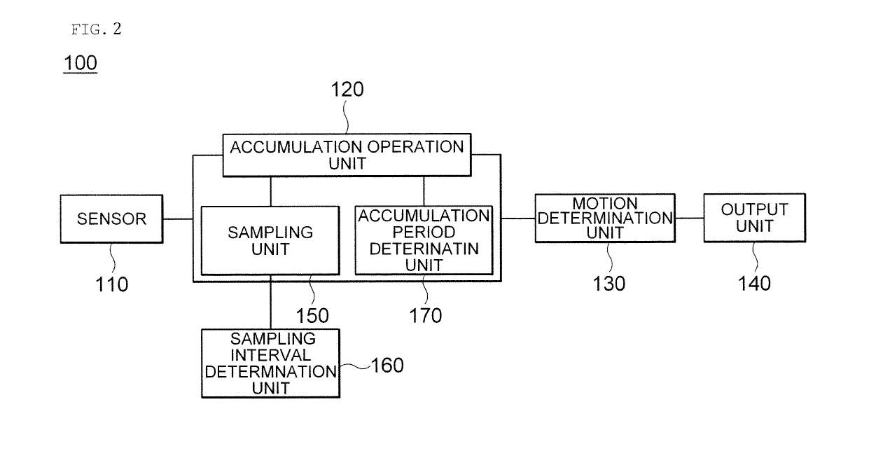

FIG. 2 is a diagram schematically showing a device 100 for detecting motions according to an exemplary embodiment of the present invention.

Referring to FIG. 2, the device 100 for detecting motions according to the exemplary embodiment of the present invention may include a sensor 110, an accumulation operation unit 120, a motion determination unit 130, and an output unit 140.

The sensor 110 performs a function of sensing an outside of the device or an operation of the device and outputting detection result signals and may be implemented by various types and principles such as an acceleration sensor, an angular velocity sensor, a gyro sensor, a geomagnetic sensor, an optical sensor, or the like.

The accumulation operation unit 120 may be connected with the sensor 110 to accumulatively sum absolute values of the detection result signals output from the sensor 110, thereby deriving a signal accumulated value.

In this case, a sampling unit 150 may be included in the accumulation operation unit 120 and may perform a function of sampling the detection result signals or an absolute value of the detection result signals at a predetermined time interval.

In addition, the sampling time interval of the sampling unit 150 may be controlled as needed and may be performed by further including a sampling interval determination unit 160.

Meanwhile, the accumulation operation unit 120 performs the accumulation operation on the absolute value of the detection result signals and the absolute value of the sampled value in a predetermined accumulation period. In this case, the accumulation operation unit 120 further includes an accumulation period determination unit 170 to control the size of the accumulation period.

The motion determination unit 130 may serve to determine whether the motions are present by comparing the signal accumulated value summed in the accumulation operation unit 120 with the preset first reference value and the output unit 140 may output the motion detection signals according to the determination results of the motion determination unit 130.

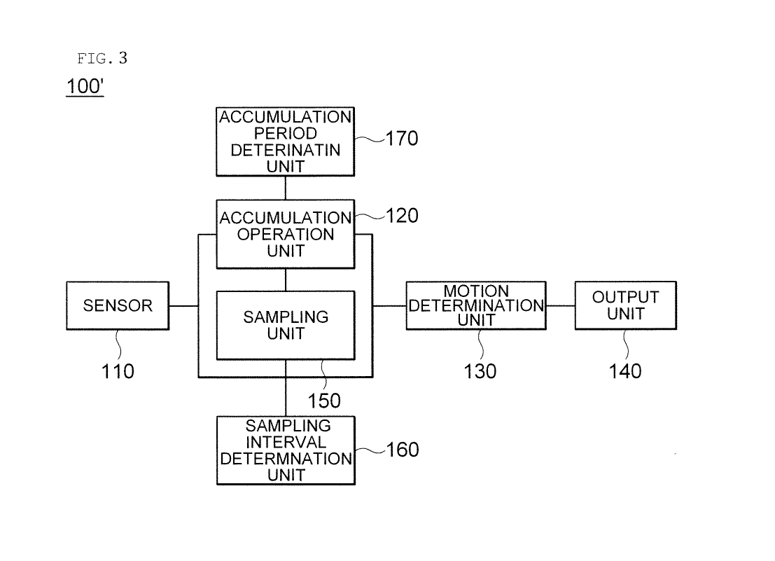

FIG. 3 is a diagram schematically showing a device 100′ for detecting motions according to another exemplary embodiment of the present invention.

It can be understood from FIG. 3 that in the device 100′ for detecting motions according to another exemplary embodiment of the present invention, the accumulation period determination unit 170 may be included at the outside of the accumulation operation unit 120.

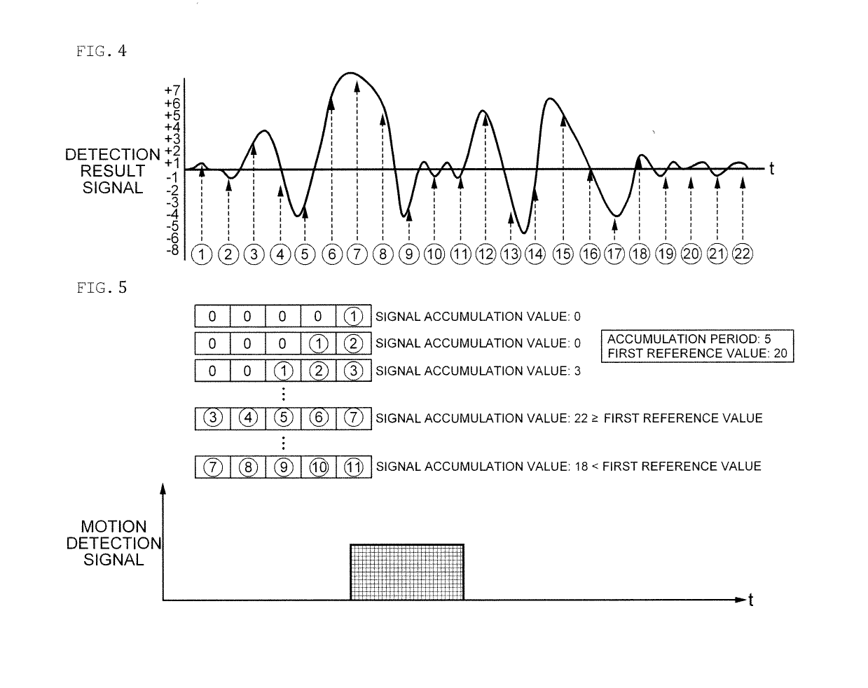

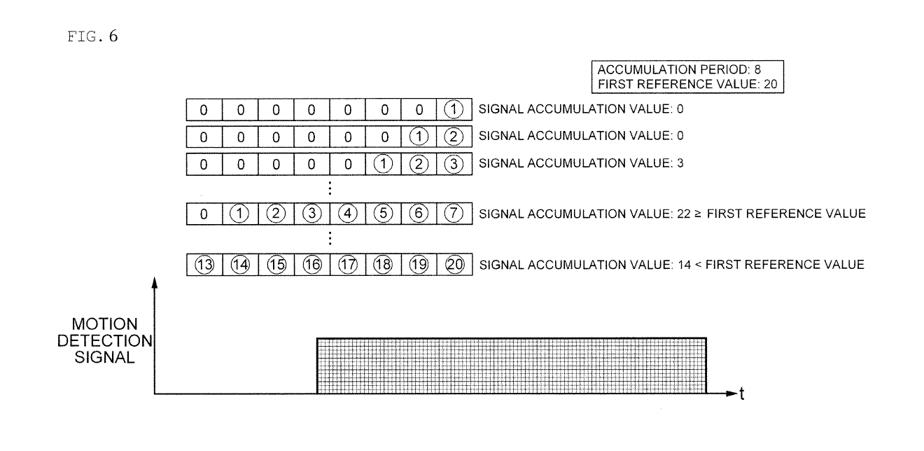

FIG. 4 is a diagram schematically showing motion result signals according to an exemplary embodiment of the present invention, FIG. 5 is a diagram schematically showing motion detection signals and a deriving principle thereof according to an exemplary embodiment of the present invention, and FIG. 6 is a diagram schematically showing motion detection signals and a deriving principle thereof according to another exemplary embodiment of the present invention.

Hereinafter, an operation principle of the device 100 for detecting motions will be described in detail with reference to FIGS. 4 to 6.

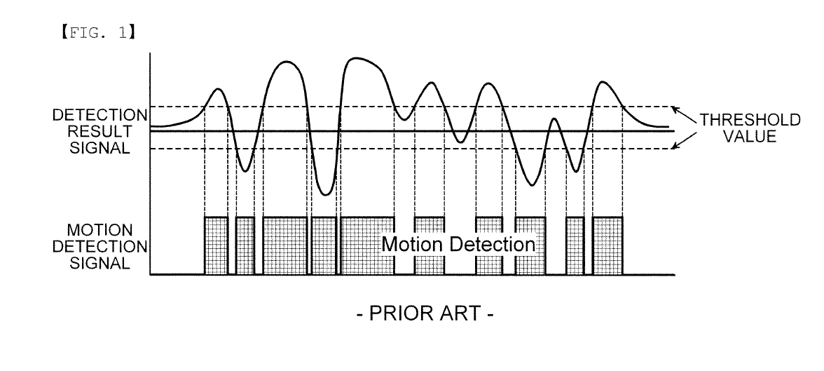

The detection result signals shown in FIG. 4, which are signals output from the sensor 110, may show an aspect similar to the output signals from the sensor 110 according to the related art shown in FIG. 1.

FIG. 5 shows a principle of outputting the motion detection signals for the detection result signals shown in FIG. 4 when the size of the accumulation period is 5 and the first reference value is set to be 20. In this case, \textcircled{1}, \textcircled{2}, \textcircled{3}, \textcircled{4}, \textcircled{5}, . . . , or the like, mean each sampling time when the detection result signals are sampled at a predetermined time interval.

As the sampling time interval is small, the accuracy of the motion detection may be improved; however, data throughput of the accumulation operation unit 120 and the motion determination unit 130 is increased, thereby causing the problems due to overload. Therefore, the sampling time interval needs to be determined in an appropriate range. To this end, the sampling time interval may be controlled by the sampling interval determination unit 160.

Referring to FIG. 5, a signal accumulation value of the signal for the accumulation period including \textcircled{1}, a signal accumulation value for the accumulation period including \textcircled{1} and \textcircled{2}, and a signal accumulation value for the accumulation period including \textcircled{1}, \textcircled{2}, and \textcircled{3} are operated in sequence.

In addition, after the signal accumulation value for the accumulation period including \textcircled{1}, \textcircled{2}, \textcircled{3}, \textcircled{4}, and \textcircled{5} is operated, the signal accumulation value for the accumulation period including \textcircled{2}, \textcircled{3}, \textcircled{4}, \textcircled{5}, and \textcircled{6} and the signal accumulation value for the accumulation period including \textcircled{3}, \textcircled{4}, \textcircled{5}, \textcircled{6}, and \textcircled{7} are operated in sequence.

That is, the absolute value of the detection result signals included in the accumulation period is accumulatively summed at a specific time while the accumulation period of which the size is 5 is sequentially progressed according to time.

The signal accumulation value operated in the accumulation operation unit 120 is transferred to the motion determination unit 130 in real time and the motion determination unit 130 determines whether the motions are present by comparing the signal accumulation value with the first reference value.

FIG. 5 shows the case in which the first reference value is 20. In this case, the signal accumulation value for the accumulation period including \textcircled{3}, \textcircled{4}, \textcircled{5}, \textcircled{6}, and \textcircled{7} is 22 and thus, first exceeds the first reference value. Thereafter, the signal accumulation value is 18 in the accumulation period including \textcircled{7}, \textcircled{8}, \textcircled{9}, \textcircled{10}, and \textcircled{11} and thus, is smaller than the first reference value.

According to the above-mentioned results, the motions start to be detected when the signal accumulation value is larger than the first reference value and the motions end when the signal accumulation value is smaller than the first reference value and the same results as the motion detection signals shown in the bottom of FIG. 5 may be output.

Meanwhile, FIG. 6 shows a principle of outputting the motion detection signals for the detection result signals shown in FIG. 4 when the size of the accumulation period is 8 and the first reference value is set to be 20.

As described above, the signal accumulation value for the accumulate period including \textcircled{1}, the signal accumulation value for the accumulate period including \textcircled{1} and \textcircled{2}, and the signal accumulation value for the accumulate period including \textcircled{1}, \textcircled{2}, and \textcircled{3} are operated in sequence.

In addition, after the signal accumulation value for the accumulation period including \textcircled{1}, \textcircled{2}, \textcircled{3}, \textcircled{4}, \textcircled{5}, \textcircled{6}, \textcircled{7}, and \textcircled{8} is operated, the signal accumulation value for the accumulation period including \textcircled{2}, \textcircled{3}, \textcircled{4}, \textcircled{5}, \textcircled{6}, \textcircled{7}, \textcircled{8}, and \textcircled{9} and the signal accumulation value for the accumulation period including \textcircled{3}, \textcircled{4}, \textcircled{5}, \textcircled{6}, \textcircled{7}, \textcircled{8}, \textcircled{9}, and \textcircled{10} are operated in sequence.

That is, the absolute value of the detection result signals included in the accumulation period is accumulatively summed at a specific time while the accumulation period of which the size is 8 is sequentially progressed according to time.

The signal accumulation value operated in the accumulation operation unit 120 is transferred to the motion determination unit 130 in real time and the motion determination unit 130 determines whether the motions are present by comparing the signal accumulation value with the first reference value.

FIG. 6 shows the case in which the first reference value is 20. In this case, the signal accumulation value for the accumulation period including \textcircled{1}, \textcircled{2}, \textcircled{3}, \textcircled{4}, \textcircled{5}, \textcircled{6}, and \textcircled{7} is 22 and thus, first exceeds the first reference value. Thereafter, the signal accumulation value is smaller than the first reference value in the predetermined accumulation period.

According to the above-mentioned results, the motions start to be detected when the signal accumulation value is larger than the first reference value and the motions end when the signal accumulation value is smaller than the first reference value and the same results as the motion detection signals shown in the bottom of FIG. 6 may be output.

In summary, as the accumulation period is increased, the accuracy of the motion detection may he improved. On the other hand, as the accumulation period is small, the delayed time detecting the operation from the time when the first motion is performed may be shortened.

Therefore, the size of the accumulation period may be controlled by using the principle and the size of the accumulation period may be determined by the accumulation period determination unit 170.

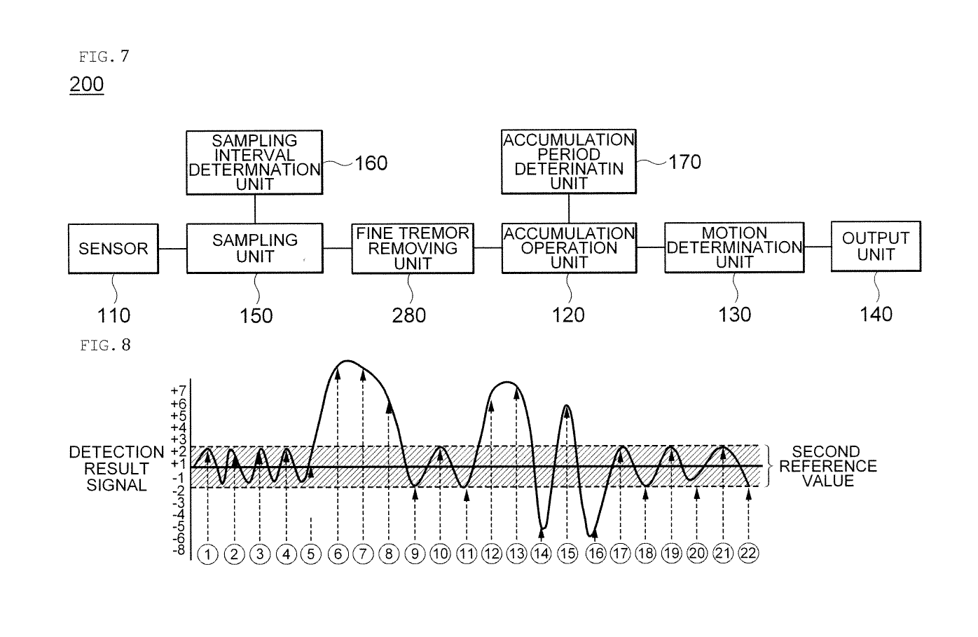

FIG. 7 is a diagram schematically showing a device 200 for detecting motions according to another exemplary embodiment of the present invention.

Hereinafter, the device 200 for detecting motions according to another exemplary embodiment of the present invention will be described with reference to FIG. 7. However, the repeated description of matters similar to the above-mentioned exemplary embodiments will be omitted.

The device 200 for detecting motions according to the exemplary embodiment of the present invention may include the sensor 110, the sampling unit 150, a fine tremor removing unit 280, the accumulation operation unit 120, the motion determination unit 130, and the output unit 140.

In the device 200 for detecting motions according to the exemplary embodiment of the present invention, the sampling unit 150 samples the detection result signals output from the sensor 110 at the predetermined time interval. In this case, the sampling interval may be controlled by the sampling interval determination unit 160 connected with the sampling unit 150.

Meanwhile, the sensor 110 implemented by various inertial sensors may reflect the fine tremor at the time of outputting the detection result signals according to the operation. When the fine tremor is reflected to the detection result signals, it is wrongly determined that the motions are present. As a result, the results where the motions are present are output and thus, the accuracy of the motion detection may be degraded.

Therefore, in the exemplary embodiment of the present invention, the fine tremor removing unit 280 is included between the sampling unit 150 and the accumulation operation unit 120, thereby more improving the accuracy of the motion detection.

The sampled value in the sampling value 150 is input to the fine tremor removing unit 280.

The fine tremor removing unit 280 serves to pass through only the value larger than a second reference value by comparing the value sampled in the sampling unit 150 with the preset second reference value In this case, the second reference value may be determined as an appropriate value so as to match conditions to which the device 100 for detecting motions is applied.

Only the meaningful values passing through the fine tremor removing unit 280 are input to the accumulation operation unit 120 and thus, the signal accumulation value may be derived through the accumulation sum.

In this case, the fine tremor removing unit 280 may process and output the value smaller than the second reference value as 0.

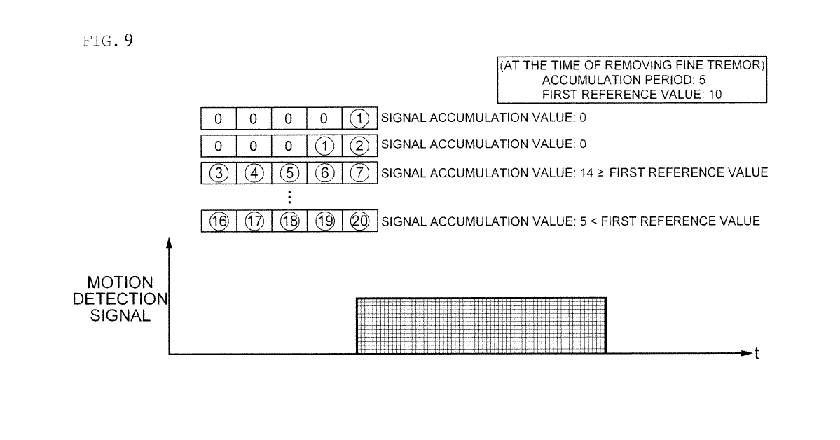

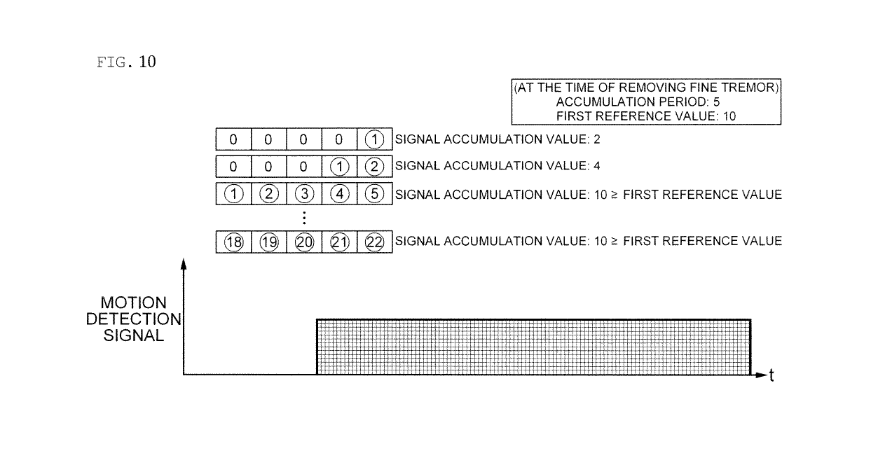

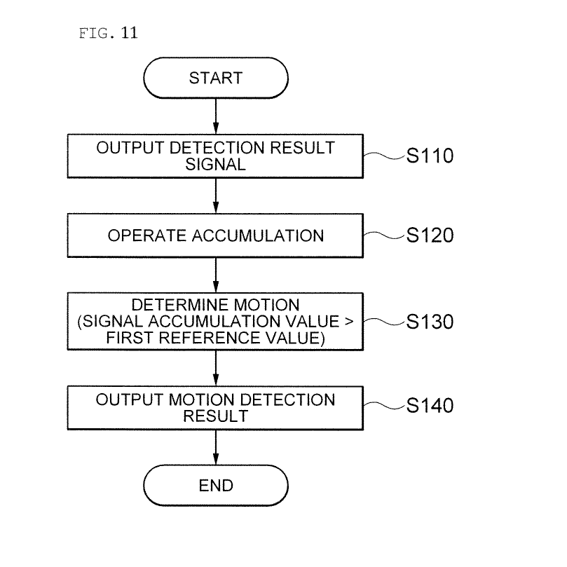

FIG. 8 is a diagram schematically showing the detection result signals according to another exemplary embodiment of the present invention, FIG. 9 is a diagram schematically showing motion detection signals and a deriving principle thereof according to another exemplary embodiment of the present invention, and FIG. 10 is a diagram schematically showing a comparative example of FIG. 9.

Hereinafter, the difference in effects when the fine tremor removing unit 280 is provided and when the fine tremor removing unit 280 is not provided will be described with reference to FIGS. 8 to 10. In this case, the repeated description with the above-mentioned description will be omitted.

It can be understood from FIG. 8 that the second reference value is set by considering the case in which the size of the detection result signal is less than about ±2.5 as the fine tremor. Meanwhile, the second reference value may be controlled according to the conditions or the environment to which the device 200 for detecting motions is applied.

Referring to FIG. 10, when the fine tremor is not removed, the sampled value is input to the accumulation operation unit 120 at the timing of \textcircled{1}, \textcircled{2}, \textcircled{3}, \textcircled{4}, and \textcircled{5}, which is reflected to the summing process.

On the other hand, referring to FIG. 9, when the fine tremor is removed, the sampled value is not input to the accumulation operation unit 120 at the timing of \textcircled{1}, \textcircled{2}, \textcircled{3}, \textcircled{4}, and \textcircled{5}, which is not reflected to the summing process.

Therefore, the inaccuracy of the motion detection due to the meaningless detection result signals may be improved by including the fine tremor removing unit 280.

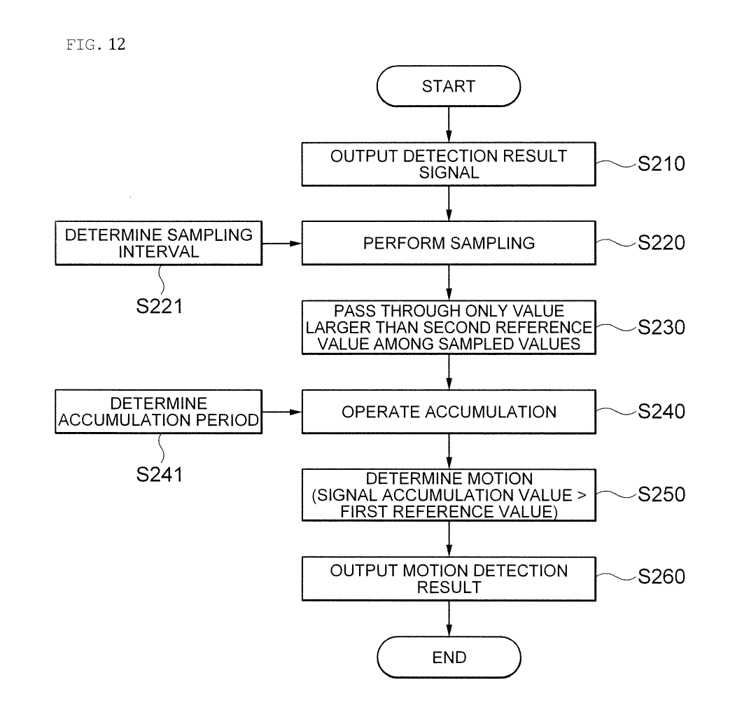

FIG. 11 is a diagram schematically showing a method for detecting motions according to an exemplary embodiment of the present invention.

Referring to FIG. 11, a method for detecting motions according to the exemplary embodiment of the present invention accumulatively sums the absolute value of the detection result signals corresponding to the predetermined accumulation period to derive the signal accumulation value (S120) when the detection result signals are output by detecting the motions in the sensor (S110).

In this case, absolute values of new detection result signals are included in the accumulation period and the signal accumulation values are sequentially derived by a method of excluding the oldest value among the absolute values of the detection result signals included in the existing accumulation period from the accumulation period.

Next, it is determined whether the motions are present by comparing the derived signal accumulation value with the predetermined first reference value (S130).

In this case, it may be determined that the motions are present when the signal accumulation value is the first reference value or more, and it may be determined that the motions end when the signal accumulation value is smaller than the first reference value.

Next, the motion detection signals are output according to the results determining whether the motions are present (S140).

FIG. 12 is a diagram schematically showing a method for detecting motions according to another exemplary embodiment of the present invention.

Referring to FIG. 12, the method for detecting motions according to another exemplary embodiment of the present invention samples the detection result signal values or the absolute values of the detection result signals at a predetermined time interval (220) when the detection result signals are output by detecting the operation in the sensor (S210).

Next, the influence due to the fine tremor is reduced by passing through only the value larger than the second reference value among the sampled values (S230). In this case, the value smaller than the second reference value among the sampled values may be processed and output as 0.

Next, the signal accumulation value is derived by accumulatively summing the absolute values of the detection result signals corresponding to the predetermined accumulation period (S240).

In this case, absolute values of new detection result signals are included in the accumulation period and the signal accumulation values are sequentially derived by a method of excluding the oldest value among the absolute values of the detection result signals included in the existing accumulation period from the accumulation period.

Next, it is determined whether the motions are present by comparing the derived signal accumulation value with the predetermined first reference value (S250).

In this case, it may be determined that the motions are present when the signal accumulation value is the first reference value or more, and it may be determined that the motions end when the signal accumulation value is smaller than the first reference value.

Next, the motion detection signals are output according to the results determining whether the motions are present (S260).

As set forth above, the device for detecting motions and the method for detecting motions according to the exemplary embodiments of the present invention can detect motions by performing the accumulation operation on the detection result signals in the predetermined accumulation period and comparing them with the reference value, thereby improving the inaccuracy of the motion sensing due to the fixing of the threshold value.

In addition, the device for detecting motions and the method for detecting motions according to the exemplary embodiments of the present invention can reflect the size of the detection result signals detected by the sensor to the determination whether the motions are present and therefore, may be used as more various applications than the related art.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A device for detecting motions, comprising:
a sensor detecting motions to output detection result signals;
an accumulation operation unit accumulatively summing absolute values of the detection result signals in a preset accumulation period to derive signal accumulation values;
a motion determination unit comparing the signal accumulation values with a preset first reference value to determine whether the motions are present; and
an output unit outputting motion detection signals according to determination results of the motion determination unit.

2. The device for detecting motions according to claim 1, wherein the accumulation operation unit further includes a sampling unit sampling the detection result signals or the absolute values of the detection result signals at a predetermined time interval.

3. The device for detecting motions according to claim 2, wherein the sampling unit further includes a sampling interval determination unit determining a time interval at which the sampling is performed.

4. The device for detecting motions according to claim 1, wherein the accumulation operation unit further includes an accumulation period determination unit determining a size of the accumulation period.

5. The device for detecting motions according to claim 3, further comprising an accumulation period determination unit determining a size of the accumulation period.

6. A device for detecting motions, comprising:
a sensor detecting motions to output detection result signals;
a sampling unit sampling absolute values of the detection result signals at a predetermined time interval;
a fine tremor removing unit comparing values sampled by the sampling unit with a preset second reference value to pass through only a value larger than the second reference value;
an accumulation operation unit accumulatively summing values passing through the fine tremor removing unit in a preset accumulation period to derive signal accumulation values;
a motion determination unit comparing the signal accumulation values with a preset first reference value to determine whether the motions are present; and
an output unit outputting motion detection signals according to determination results of the motion determination unit.

7. The device for detecting motions according to claim 6, wherein the sampling unit further includes a sampling interval determination unit determining a time interval at which the sampling is performed.

8. The device for detecting motions according to claim 6, further comprising an accumulation period determination unit determining a size of the accumulation period.

9. A method for detecting motions, comprising:
(a) detecting motions in a sensor to output detection result signals;
(b) accumulatively summing absolute values of the detection result signals in a preset accumulation period to derive signal accumulation values;
(c) comparing the signal accumulation values with a preset first reference value to determine whether the motions are present; and
(d) outputting motion detection signals according to results determining whether the motions are present.

10. The method for detecting motions according to claim 9, wherein step (c) determines that the motions are present when the signal accumulation values are the first reference value or more, and
determines that the motions end when the signal accumulation values are smaller than the first reference value.

11. A method for detecting motions, comprising:
(A) detecting motions in a sensor to output detection result signals;
(B) sampling absolute values of the detection result signals at a predetermined time interval;
(C) comparing sampled values with a preset second reference value to pass through only a value larger than the second reference value;
(D) accumulatively summing the passing values at step (C) in a preset accumulation period to derive signal accumulation values;
(E) comparing the signal accumulation values with a preset first reference value to determine whether the motions are present; and
(F) outputting motion detection signals according to results determining whether the motions are present.

12. The method for detecting motions according to claim 11, wherein step (E) determines that the motions are present when the signal accumulation values are the first reference value or more, and
determines that the motions end when the signal accumulation values are smaller than the first reference value.
